(19) United States
(12) Patent Application Publication
(10) Pub. No.: US 2016/0298448 A1
(43) Pub. Date: Oct. 13, 2016

(54) NEAR BIT MEASUREMENT MOTOR

(71) Applicant: Scientific Drilling International, Inc., Houston, TX (US)

(72) Inventors: Gerald HEISIG, Houston, TX (US); Brian GLEASON, Atascadero, CA (US)

(21) Appl. No.: 15/094,669

(22) Filed: Apr. 8, 2016

Related U.S. Application Data
(60) Provisional application No. 62/146,025, filed on Apr. 10, 2015.

(51) Int. Cl. E21B 47/12; G01V 3/34; E21B 47/06; E21B 47/16; E21B 4/02

(52) U.S. Cl. CPC E21B 47/12; E21B 47/122; E21B 47/16; E21B 4/02; E21B 47/065; E21B 47/124; G01V 3/34

(57) ABSTRACT

A bottom hole assembly may include a mud motor, the mud motor including a stator and a rotor, the rotor rotatable eccentrically in response to a fluid being pumped through the mud motor. The bottom hole assembly may also include a housing, the housing mechanically coupled to the stator of the mud motor. The bottom hole assembly may further include a flex shaft, the flex shaft positioned within the housing and mechanically coupled to the rotor such that it is rotated by the rotor. The bottom hole assembly may also include an intermediate shaft, the intermediate shaft positioned within the housing and mechanically coupled to the flex shaft. The intermediate shaft may include a MWD package. The MWD package includes at least one sensor.

### CROSS-REFERENCE TO RELATED APPLICATIONS

This application is a nonprovisional application which claims priority from U.S. provisional application number 62/146,025, filed Apr. 10, 2015.

### TECHNICAL FIELD/FIELD OF THE DISCLOSURE

The present disclosure relates generally to a measurement while drilling (MWD) system, and specifically to a near bit MWD used in conjunction with a mud motor.

### BACKGROUND OF THE DISCLOSURE

Accurately determining the position and orientation of a drilling assembly during drilling operations may be desirable, particularly when drilling deviated wells. Traditionally, a combination of sensors is used to measure downhole trajectory and subterranean conditions. Data collected in this fashion is traditionally transmitted to the surface via MWD telemetry. Many factors may combine to unpredictably influence the trajectory of a drilled borehole. Accurate determination of the borehole trajectory may be used to determine the position of the borehole and to guide the borehole to its geological objective as well as avoiding collisions with underground objects, geological features, wells, or zones. In other cases, it is desired to intercept underground objects, geological features, wells, or zones.

In some instances, surveying of a borehole using conventional methods involves the periodic measurement of the Earth's magnetic and gravitational fields to determine the azimuth and inclination of the borehole at the bottom hole assembly. In some instances, the distance, orientation, or both the distance and orientation of a borehole relative to other boreholes is determined by periodically or continuously measuring the magnetic field that is produced either passively from the adjacent wellbore's casing or drillpipe or by measuring an actively generated magnetic field.

As the wellbore is drilled, the greater the distance between the drill bit and sensors, commonly known as a MWD package, the longer it takes for any changes in the azimuth, inclination, relative distance, or relative orientation of the wellbore at the drill bit to be recognized by an operator. In some bottom hole assemblies, some equipment used in the bottom hole assembly, such as a mud motor, may move traditional MWD packages a long distance from the drill bit, and thus delay feedback or impede accuracy on azimuth and inclination data of the wellbore.

### SUMMARY

An embodiment includes a bottom hole assembly for use in a wellbore. The bottom hole assembly includes a mud motor, the mud motor including power section. The power section includes a stator and a rotor, the rotor rotatable eccentrically in response to a fluid being pumped through the mud motor. The bottom hole assembly further includes a housing, the housing mechanically coupled to the stator of the mud motor. The bottom hole assembly further includes a flex shaft, the flex shaft positioned within the housing and mechanically coupled to the rotor such that it is rotated by the rotor. The bottom hole assembly further includes an intermediate shaft, the intermediate shaft positioned within the housing and mechanically coupled to the flex shaft. The intermediate shaft includes a MWD package. The MWD package includes at least one sensor.

Another embodiment includes a bottom hole assembly for use in a wellbore. The bottom hole assembly includes a mud motor, the mud motor including a power section. The power section includes a stator and a rotor, the rotor rotatable eccentrically in response to a fluid being pumped through the mud motor. The bottom hole assembly further includes a housing, the housing mechanically coupled to the stator of the mud motor. The bottom hole assembly further includes a flex shaft, the flex shaft positioned within the housing and mechanically coupled to the rotor and rotatable by the rotor. The bottom hole assembly further includes an intermediate shaft, the intermediate shaft positioned within the housing and mechanically coupled to the flex shaft. The intermediate shaft includes a MWD package, wherein the MWD package includes at least one sensor. The bottom hole assembly further includes a bent sub, the bent sub mechanically coupled to the housing, a bit shaft, the bit shaft mechanically coupled to the intermediate shaft, and a drill bit, the drill bit mechanically coupled to the bit shaft.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a cross section of a bottom hole assembly consistent with embodiments of the present disclosure.

FIG. 2 depicts a schematic view of a MWD package consistent with embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

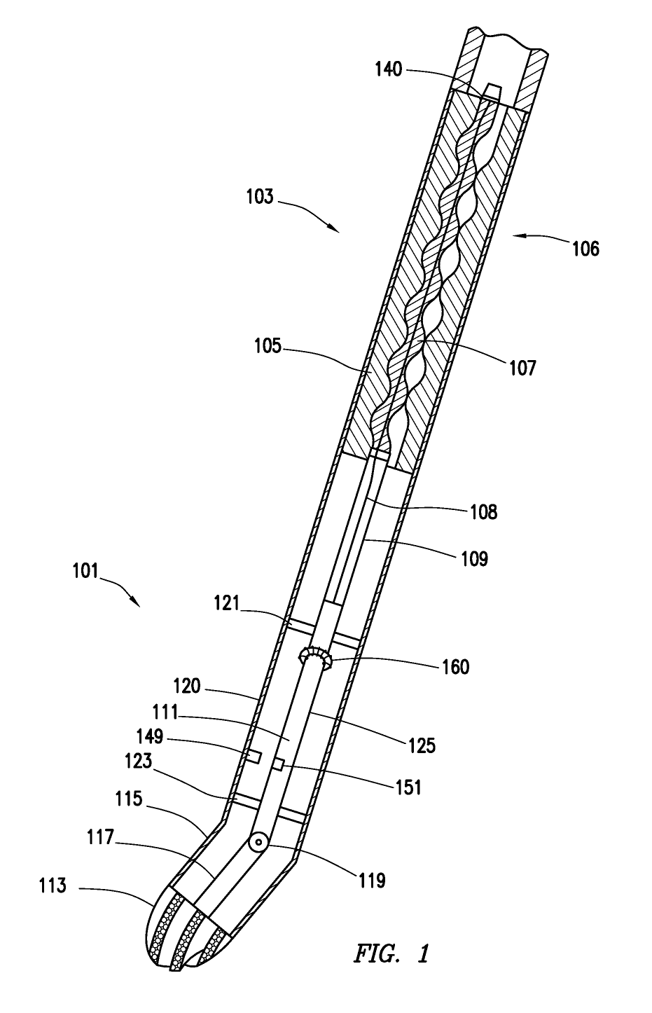

In some embodiments of the present disclosure as depicted in FIG. 1, bottom hole assembly (BHA) 101 may include mud motor 103, having power section 106, which includes stator 105 and rotor 107. Rotor 107 may rotate eccentrically within stator 105 as fluids are pumped through mud motor 103. In some embodiments, rotor 107 of power section 106 may be mechanically coupled by flex shaft 109 to intermediate shaft 111. Flex shaft 109 may serve to transmit rotational force between rotor 107 and intermediate shaft 111 and allow the eccentric movement of rotor 107 within stator 105 to be translated into the concentric rotation of intermediate shaft 111. Intermediate shaft 111 may, in some embodiments, transmit rotational force between mud motor 103 and drill bit 113. As understood in the art, one or more additional assemblies may be included in BHA 101 including, for example and without limitation, bent sub 115. In some embodiments, drill bit 113 may be mechanically coupled to bit shaft 117 which may be mechanically coupled to intermediate shaft 111 by, for example and without limitation, CV joint or knuckle joint 119.

In some embodiments, intermediate shaft 111 may be positioned within housing 120. In some embodiments, intermediate shaft 111 may be supported within housing 120 by one or more bearings, depicted in FIG. 1 as upper bearing 121 and lower bearing 123. Housing 120 may couple between mud motor 103 and any additional components of BHA 101 such as, for instance and without limitation, bent sub 115.

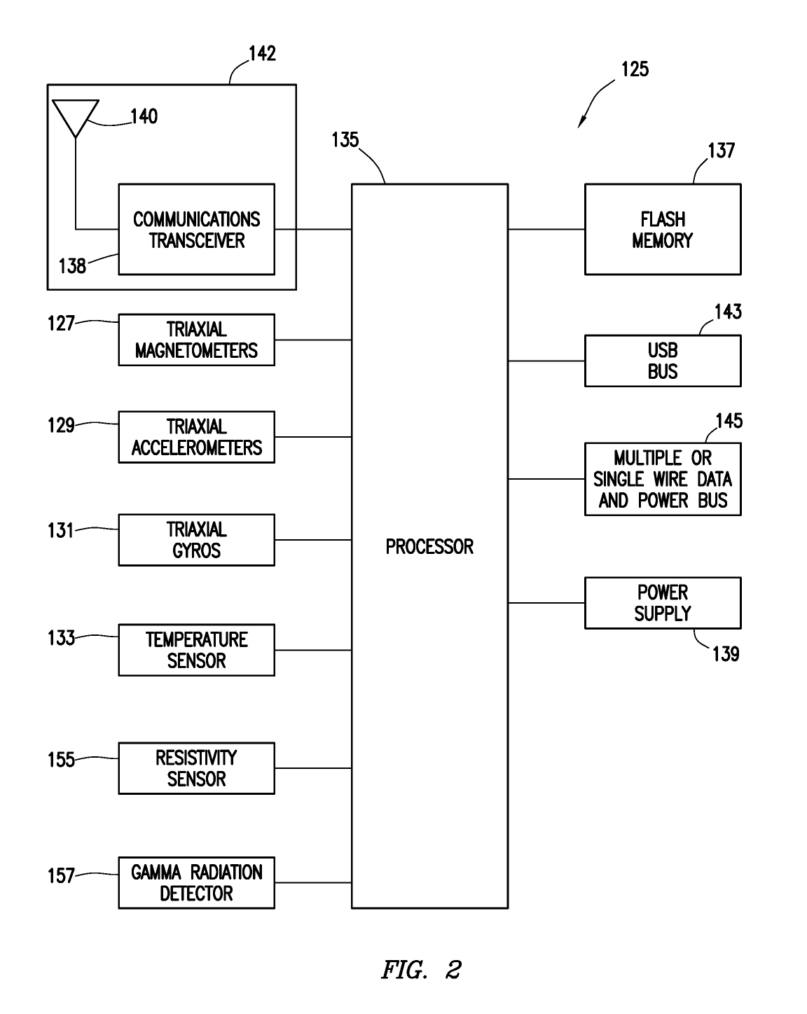

In some embodiments of the present disclosure, intermediate shaft 111 may be a hollow, generally tubular structure. In some embodiments of the present disclosure, MWD package 125 may be positioned within intermediate shaft 111. As depicted schematically in FIG. 2, MWD package 125 may include one or more sensors. The sensors may include, for example and without limitation, one or more magnetometers 127, accelerometers 129, gyros 131, temperature sensors 133, formation resistivity sensors 155, and gamma radiation detectors 157. As understood in the art, magnetometers 127, accelerometers 129, and gyros 131 may include multiple sensors to measure parameters in more than one axis, including, without limitation, in three orthogonal directions, commonly known as a triaxial arrangement.

In some embodiments, MWD package 125 may further include processor 135 and associated memory 137 to gather, receive, store, process, and/or transmit signals from the sensors. In some embodiments, processor 135 may receive and process commands. In some embodiments, MWD package 125 may be able to gather, receive, store, process, and/or transmit, for example and without limitation, one or more of total magnetic field strength, inclination, RPM, magnetometer data, accelerometer data, temperature, formation resistivity, gamma count, voltage and current data, date/time, and toolface.

In some embodiments, MWD package 125 may include power source 139 to power one or more of the sensors and processor 135. In certain embodiments, power source 139 may provide power to transceiver 138, described hereinbelow. In some embodiments, power source 139 may include, for example and without limitation, one or more batteries or generators. Power source 139 may be integral to MWD package 125 or connected to MWD package 125 via a wire. In some embodiments, power source 139 may be positioned within intermediate shaft 111. In some embodiments, power source 139 may be electrically coupled to but located apart from intermediate shaft 111. For example and without limitation, in some embodiments, power source 139 may be positioned in one or more of power section 106, bit shaft 117, or an additional rotating collar mechanically coupled to intermediate shaft 111. In other embodiments, power source 139 may be located above, i.e., closer to the surface than, mud motor 103. In such an embodiment, one or more wires may be passed through an interior of rotor 105 to transit mud motor 103. In some embodiments, power source 139 may be a generator positioned to provide power to MWD package 125. In some embodiments, the generator may be mechanically coupled to a shaft (not shown) mechanically coupled to rotor 107 of power section 106 at the end opposite intermediate shaft 111.

In some embodiments, MWD package 125 may communicate with additional pieces of wellbore equipment such as, for instance, an MWD tool positioned above mud motor 103 (not shown) or to the surface. Such communication may be unidirectional or bidirectional. Communications to and from MWD package 125 may be accomplished through, for instance, transmission through drilling fluid, acoustic transmission or electromagnetic transmission. Communications to and from MWD package 125 may be through different media. For example, communications from the surface to MWD package 125 may be made through electromagnetic transmission and communications from MWD package 125 to an MWD tool above mud motor 103 may be made through acoustic transmission. In some embodiments, communication to MWD 125 package may be achieved by changing mud flow rate, thereby changing mud motor 103 rotor speed, which can be sensed by a rotation sensitive sensor such as a gyroscope in MWD package 125.

In certain embodiments, MWD package 125 may communicate with other equipment through communications subsystem 142. When communications to and from MWD package 125 is made through pressure or acoustic signals, communications subsystem 142 may include a transducer. When communication to and from MWD package 125 is made through wireless connection, communications subsystem 142 may include or be electrically coupled to transceiver 138 which may be electrically coupled to antenna 140 positioned to connect to an MWD tool (not shown) positioned above the motor. Although shown as an antenna, antenna 140 may also be a transducer or acoustic transmitter.

In some embodiments, antenna 140 may be a loop antenna. In some embodiments, antenna 140 may be a toroidal antenna, a gap antenna or an electrode antenna such as a ring, strip or button electrode. In other embodiments, such as when an MWD tool is located above the motor, wireless communication may be accomplished through acoustic transmission through the drilling fluid, including, for instance, drilling fluid pumped through the drill collar and mud motor 103, through the drilling fluid returning to the surface through the annulus, or through the propagation medium formed by the metal of mud motor 103 and the drill collar.

In some embodiments, MWD package 125 may communicate with additional pieces of wellbore equipment by a wire connection. In some embodiments, one or more data or power wires 108 may pass through an interior of power section 106 to transit mud motor 103. In some embodiments, power section 106 may be used to transmit data through mud motor 103. In these embodiments, power section 106 forms an axial conducting loop in which a signal current can be induced or read out, e.g., by toroidal antenna 160. In certain of these embodiments, toroidal antenna 160 may have a permeable toroidal core and one or more windings wrapped around the core. In some embodiments, the data wires may connect to an MWD tool (not shown) positioned above the motor.

In some embodiments, the data wires or power wires 108 may connect to antenna 140 which may be mechanically coupled to end of rotor 107 opposite the coupling to flex shaft 109. In other embodiments, antenna 140 may be positioned on intermediate shaft 111. Antenna 140 may be positioned to allow MWD package 125 to communicate with additional pieces of wellbore equipment or with the surface. Antenna 140 may transmit or receive data via electrical conduction, propagated electromagnetic waves, magnetically induced currents, magnetic coupling, inductive coupling, or capacitive coupling. In some embodiments, antenna 140 may be one or more contactless inductive or capacitive couplers. In some such embodiments, rotor 107 and flex shaft 109 may include a central bore which may allow one or more data or power wires 108 to pass therethrough, thereby electrically coupling MWD package 125 to antenna 140. In some embodiments, a second flex shaft mechanically coupled above mud motor 103 to rotor 105 may allow any data or power wires 108 to connect to a concentrically rotating collar above mud motor 103. In some embodiments, one or more swivel rings (not shown) may be positioned to allow electric communication between the data wires and non-rotating equipment.

In some embodiments, MWD package 125 may include USB bus 143, to allow for connectivity between MWD package 125 and additional equipment. In some embodiments, MWD package 125 may include a multiple or single wire power and data bus 145 to allow for connectivity between MWD package 125 and additional equipment.

In some embodiments of the present disclosure, in order to, for example, radially orient sensors of MWD package 125 with respect to housing 120, element 149 may be mechanically coupled to housing 120 at a preselected position. In some embodiments, the preselected position may correspond to the high side of bent sub 115 (not shown). MWD package 125 may include orientation system 151. Orientation system 151 may be mechanically coupled to intermediate shaft 111. In certain embodiments, original system 151 may be positioned such that when intermediate shaft 111 rotates within housing 120, orientation system 151 detects element 149 when orientation system 151 is in sensing range to element 149. Element 149 either actively (“active element”) or passively (passive element) provides an indication of its position relative to the orientation system 151. In certain embodiments, element 149 may actively emit a signal such as an electrical signal, electromagnetic field, optical signal, a magnetic field, or an acoustic signal. In other embodiments, element 149 is a passive element such as a metal that can be detected by orientation system 151. In an embodiment, element 149 is a magnet positioned at a known angular orientation and position on housing 120 or bent sub 115. “Magnet” includes any material that emits a magnetic field. A sensor in orientation system 151 may detect magnetic signals such as that emitted by element 149, will come into contact with magnetic fields of the magnet during rotation. The location of element 149 relative to housing 120 and/or bent sub 115 is known. Rotation speed, inclination and orientation, such as tool face orientation of the housing 120 or bent sub 115 may be calculated by MWD package 125 processor. In other embodiments, element 149 may include an arrangement of active or passive elements ordered in a known radial pattern to improve resolution in the determined relative angular position. In some embodiments, orientation system 151 includes more than one sensor with sensitive axes arranged at known relative angular displacements with respect to one another to improve resolution in the determined relative angular position. In other embodiments, MWD package 125 may be radially oriented within housing 120 with respect to the surrounding formation as it rotates.

In some embodiments, one or more components of BHA 101 may be constructed from non-magnetic materials. Magnetic materials may, for example, interfere with proper functioning of magnetometers 127. In some embodiments, components of BHA 101 which may be formed from nonmagnetic materials may include, for example and without limitation, one or more of bit 113, bit shaft 117, bent sub 115, CV joint or knuckle joint 119, upper and lower bearings 121, 123, housing 120, intermediate shaft 111, and mud motor 103 (including stator 105 and rotor 107). In some embodiments, the influence of the magnetic materials on the magnetic sensors in the MWD package may be removed either through a priori or in-situ calibration techniques, including, but not limited to, correction algorithms. The correction algorithms may be stored in a non-transitory computer readable medium.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A bottom hole assembly for use in a wellbore, the bottom hole assembly comprising:
a mud motor, the mud motor including a power section, the power section including a stator and a rotor, the rotor rotatable eccentrically in response to a fluid being pumped through the mud motor;
a housing, the housing mechanically coupled to the stator of the mud motor;
a flex shaft, the flex shaft positioned within the housing and mechanically coupled to the rotor such that it is rotated by the rotor; and
an intermediate shaft, the intermediate shaft positioned within the housing and mechanically coupled to the flex shaft, the intermediate shaft rotatable concentrically with the housing, the intermediate shaft including a MWD package, the MWD package including at least one sensor.

2. The bottom hole assembly of claim 1, wherein the intermediate shaft is mechanically coupled to a drill bit, the drill bit rotated by the rotation of the intermediate shaft.

3. The bottom hole assembly of claim 1, wherein the MWD package further comprises at least one of a magnetometer, accelerometer, gyro, temperature sensor, formation resistivity sensor or gamma radiation detector.

4. The bottom hole assembly of claim 1, wherein the housing, flex shaft, intermediate shaft, mud motor or a combination thereof is at least partially formed from a nonmagnetic material.

5. The bottom hole assembly of claim 1, further comprising an element mechanically coupled to the housing and an orientation system mechanically coupled to the intermediate shaft, orientation system positioned to, as the intermediate shaft rotates within the housing, detect the element when the orientation system is in the sensing range to the element.

6. The bottom hole assembly of claim 5, wherein the element is an active element.

7. The bottom hole assembly of claim 6, wherein the element emits an electrical signal, electromagnetic field, an optical signal, a magnetic field, or an acoustic signal.

8. The bottom hole assembly of claim 5, wherein the element is a passive element.

9. The bottom hole assembly of claim 1, wherein the MWD package is electrically connected to a communications subsystem.

10. The bottom hole assembly of claim 9, wherein the communications subsystem includes a transceiver and an antenna, wherein the antenna is in electrical connection with the transceiver.

11. The bottom hole assembly of claim 10, wherein the antenna is adapted to transmit and or receive data via electrical conduction, propagated electromagnetic waves, magnetically induced currents, magnetic coupling, inductive coupling, or capacitive coupling.

12. The bottom hole assembly of claim 10, wherein the antenna is positioned on the rotor at an end of the rotor opposite the coupling of the rotor to the flex shaft, and the antenna electrically coupled to the MWD package by at least one data or power wire passing through the interior of the rotor.

13. The bottom hole assembly of claim 10, wherein the antenna is positioned on the intermediate shaft.

14. The bottom hole assembly of claim 10, wherein the antenna comprises one of a toroidal antenna, a gap antenna, an electrode antenna.

15. The bottom hole assembly of claim 14, wherein the electrode antenna is a ring electrode, a strip electrode, or a button electrode.

16. The bottom hole assembly of claim 9, wherein the communications subsystem comprises a transducer or acoustic transmitter.

17. The bottom hole assembly of claim 1, wherein at least one data or power wire passes through an interior of the flex shaft.

18. The bottom hole assembly of claim 1, wherein the MWD package further comprises a power source.

19. The bottom hole assembly of claim 18, wherein the power source is a battery or a generator.

20. The bottom hole assembly of claim 1, wherein the MWD package further comprises a processor to gather, receive, store, process, and/or transmit signals from the at least one sensor.

21. A bottom hole assembly for use in a wellbore, the bottom hole assembly comprising:
a mud motor, the mud motor including a power section, the power section including a stator and a rotor, the rotor eccentrically rotatable in response to a fluid being pumped through the mud motor;
a housing, the housing mechanically coupled to the stator of the mud motor;
a flex shaft, the flex shaft positioned within the housing and mechanically coupled to the rotor and rotatable by the rotor;
an intermediate shaft, the intermediate shaft positioned within the housing and mechanically coupled to the flex shaft, the intermediate shaft rotatable concentrically with the housing, the intermediate shaft including a MWD package, the MWD package including at least one sensor;
a bent sub, the bent sub mechanically coupled to the housing;
a bit shaft, the bit shaft mechanically coupled to the intermediate shaft; and
a drill bit, the drill bit mechanically coupled to the bit shaft.

22. The bottom hole assembly of claim 21, wherein the bit, bit shaft, bent sub, housing 120, flex shaft, intermediate shaft, mud motor or a combination thereof are composed of a non-magnetic material.

23. The bottom hole assembly of claim 22, further comprising an element mechanically coupled to the bent sub and an orientation system mechanically coupled to the intermediate shaft, orientation system positioned to, as the intermediate shaft rotates within the housing, detect the element when the orientation system is generally in the sensing range to the element.
